(19) United States
(12) Patent Application Publication
(10) Pub. No.: US 2018/0039731 A1
(43) Pub. Date: Feb. 8, 2018

(54) Ensemble-Based Research Recommendation Systems And Methods

(71) Applicant: Nantomics, LLC, Culver City, CA (US)

(72) Inventor: Christopher Szeto, Soquel, CA (US)

(21) Appl. No.: 15/555,290

(22) PCT Filed: Mar. 3, 2016
(86) PCT No.: PCT/US2016/020742

§ 371 Date: Sep. 1, 2017

Related U.S. Application Data
(60) Provisional application No. 62/127,546, filed on Mar. 3, 2015.

(51) Int. Cl. G06F 19/24; G06F 19/00; G06F 19/18

(52) U.S. Cl. CPC G06F 19/24; G06F 19/18; G06F 19/345

(57) ABSTRACT

A machine learning engine is presented. The disclosed recommendation engine generates an ensemble of trained machine learning models that are trained on known genomic data sets and corresponding known clinical outcome data sets. Each model can be characterized according to its performance metric or other attributes describing the nature of the trained model. The attributes of the models can also relate to one or more potential research projects, possibly including drug response studies, drug or compound research, types of data to collect, or other topics. The potential research projects can be ranked according to the performance or characteristic metrics of models that share common attributes with the potential research projects. Projects having high rankings according to the model metrics are considered as targeting that would likely be most insightful.

This application claims the benefit of priority to U.S. provisional application 62/127,546 filed on Mar. 3, 2015. This and all other extrinsic references referenced herein are incorporated by reference in their entirety.

### FIELD OF THE INVENTION

The field of the invention is ensemble-based machine learning technologies.

### BACKGROUND

The background description includes information that may be useful in understanding the present inventive subject matter. It is not an admission that any of the information provided herein is prior art or relevant to the presently claimed inventive subject matter, or that any publication specifically or implicitly referenced is prior art.

Computer-based machine learning technologies have grown in use over the last several years in parallel with interest in “big data”, where data sets far exceed the capacity of human beings to assimilate. Machine learning algorithms allow researchers to sift through data sets in a reasonable amount of time to find patterns or to build digital models capable of making predictions. Typically, researchers use a specific type of algorithm to answer a specific question. This approach is quite useful for specific tasks where the nature of the analysis data set aligns well with underlying mathematical assumptions inherent with the algorithms For example, a large data set that can be easily classified into two categories would likely be best analyzed by a support vector machine (SVM) that is designed specifically for classification based on geometric assumptions. Although specific analysis tasks can benefit from specific algorithms, applying such algorithms to more generic projects having data that is less clean or less aligned with the underlying mathematical assumptions to the algorithm can be problematic.

One problem with using specific algorithms on more general data is that the underlying mathematical assumptions of the algorithms can adversely impact the conclusions generated from applying the algorithms to the data. Said another way, results from different types of algorithms will be different from each other even when applied to the same data sets. Thus, the assumptions of the algorithms affect the outputs, which can lead the researcher to make uncertain or less confident conclusions if the nature of the data lacks ideal alignment with the algorithm's underlying assumptions. In such scenarios, researchers need techniques to mitigate the risk of uncertain conclusions induced by algorithm assumptions.

Even assuming a researcher is able to mitigate the risks incurred by algorithm assumptions, the research likely encounters one or more overriding problems especially when faced with many data sets on many different topics, and faced with many possible directions in which to take their research in view of limited resources (e.g., money, time, compute power, etc.). Consider a scenario where a researcher has access to hundreds of different clinical data sets associated with many different drug studies. Assume the researcher is tasked with the objective of determining which drug should be a target of continued research based on the available data. Finding a recommended course of actions could be a quite tedious project. The researcher could review each data set for each drug study to determine which type of machine learning algorithm would be best suited for each data set. The researcher could use each data set to train the selected specific machine learning algorithm that corresponds to the data set. Naively, the researcher might then compare the prediction accuracy of the resulting trained models to each other and select the drug that has a trained model that appears most accurate.

Unfortunately, the each trained algorithm is still subject to the risks associated with its own assumptions. Although the researcher attempts to match the most proper algorithm to a data set, such a matching is rarely ideal and is still subject to the researcher's bias even if it is unintentional. Further, the accuracy of a trained algorithm on a single data set, even accounting for cross fold validation, cannot be relied upon in cases where trained algorithm is over-trained. For example, a trained algorithm could have 100% accuracy for the training data, but still might not accurately reflect reality. In cases where there are a large number of data sets and possible directions on which to focus, it would be desirable to be able to gain insight into which direction would offer the greatest potential learning gain. A better approach would mitigate the risks associated with the algorithm assumptions while also removing possible bias of the researcher when selecting algorithms to use, and while further accounting for algorithms that could be over-trained.

Some effort has been put forth to determine which model might offer the best information with respect to specific topics. For example, U.S. patent application publication 2014/0199273 to Cesano et al. titled “Methods for Diagnosis, Prognosis, and Methods of Treatment”, filed Nov. 21, 2013, discusses selection of models that are to be used in a prediction or a prognosis in a healthcare setting. Although Cesano discusses selecting a model from multiple models, Cesano fails to provide insight into how models can be leveraged beyond merely their prediction outputs.

Further progress appears to have been made in using computer-based molecular structural models, rather than prediction models, as described in U.S. patent application publication 2012/0010866 to Ramnarayan titled “Use of Computationally Derived Protein Structures of Genetic Polymorphisms in Pharmacogenomics for Drug Design and Clinical Applications”, filed Apr. 26, 2011. Ramnarayan discusses generating 3-D models of protein structural variants and determining which drugs might satisfactorily dock with the variants. The models can then be used to rank potential drug candidates based on how well a drug model docks to the proteins. Still, Ramnarayan remains focus on 3D models per se and their use rather than creation of prediction outcomes models that can be leveraged to determine where to allocate research resources.

A more typical use of outcome models is discussed in U.S. patent application publication 2004/0193019 to Wei titled “Method for Predicting an Individual's Clinical Treatment Outcome from Sampling a Group of Patient's Biological Profiles”, filed Mar. 24, 2003. Wei discusses using discriminant analysis-based pattern recognition to generate a model that correlates biological profile information with treatment outcome information. The prediction model is used to rank possible responses to treatment. Wei simply builds prediction outcome models to make an assessment of likely outcomes based on patient-specific profile information. Wei also fails to appreciate that the models have value rather than just their output and offer more insight regarding which type of research might yield value rather merely using output from a generated model.

Ideally researchers or other stakeholders would have access to additional information from an ensemble prediction models (i.e., trained algorithms) that would ameliorate the assumptions across models while also providing an indication of which possible direction would likely offer the most return. Thus, there remains a need for machine learning systems that can provide insight into which research projects associated with many data sets would likely yield most information based on the nature of an ensemble of models generated from many different types of prediction models.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the inventive subject matter are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventive subject matter are approximations, the numerical values set forth in the specific examples are reported as precisely as practicable. The numerical values presented in some embodiments of the inventive subject matter may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventive subject matter and does not pose a limitation on the scope of the inventive subject matter otherwise claimed. No language in the specification should be construed as indicating any non-claimed element essential to the practice of the inventive subject matter.

Groupings of alternative elements or embodiments of the inventive subject matter disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY

The inventive subject matter provides apparatus, systems and methods in which a machine learning computer system is able to generate rankings or recommendations on potential research projects (e.g., drug analysis, etc.) based on an ensemble of generated trained machine learning models. One aspect of the inventive subject matter includes a research project machine learning computer system (e.g., a computing device, distributed computing devices working in concert, etc.) that includes at least one non-transitory computer readable memory (e.g., Flash, RAM, HDD, SSD, RAID, SAN, NAS, etc.), at least one processor (e.g., CPUs, GPUs, Intel® i7®, AMD® Opteron®, ASICs, FPGAs, etc.), and at least one modeling computer or engine. The memory is configured to store one or more data sets representing information associated with healthcare data. More specifically, the data sets can include a genomic data set representing genomic information from one or more tissue samples associated with a cohort patient population. Thus, the genomic data set could include genomic data from hundreds, thousands, or more patients. The data sets can also include one or more clinical outcome data set representing the outcome of a treatment for the cohort. For example, the clinical outcome data set might include drug response data (e.g., IC50, GI50, etc.) with one or more patients whose genomic data is also present in the genomic data sets. The data sets can also include metadata or other properties that describe one or more aspects associated with one or more potential research projects; types of analysis studies, types of data to collect, prediction studies, drugs, or other research topics of interest. The modeling engine or computer is configured to execute on the processor according to software instructions stored in the memory and to build an ensemble of prediction models from at the least the genomic data sets and the clinical outcome data sets. The modeling engine is configured to obtain one or more prediction model templates that represent implementations of possible machine learning algorithms (e.g., clustering algorithms, classifier algorithms, neural networks, etc.). The modeling engine or computer generates an ensemble of trained clinical outcome prediction models by using the genomic data set and the clinical outcome data set as training input to the prediction model templates. In some embodiments, the ensemble could include thousands, tens of thousands, or even more than a hundred thousand trained models. Each of the trained models can include model characteristic metrics that represent one or more performance measures or other attributes of each model. The model characteristic metrics can be considered as describing the nature of its corresponding model. Example metrics could include accuracy, accuracy gain, a silhouette coefficient, or other type of performance metric. Such metrics can then be correlated with the nature or attributes of the input data sets. In view that the genomic data set and clinical outcome data set share such attributes with the potential research projects, the metrics from the models can be used to rank potential research projects. The ranking of the research projects according to the model characteristics metric, especially ensemble metrics, can give an indication of which projects might generate the most useful information as evidenced by the generated models.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an overview of a research project recommendation system.

FIG. 2 illustrates generation of an ensemble of outcome prediction models.

FIG. 3A represents the predictability of drug responses as ranked by the average accuracy of models generated from validation data sets for numerous drugs.

FIG. 3B represents the predictability of drug responses from FIG. 3A as re-ranked by the average accuracy gain of models generated from validation data sets for numerous drugs and that suggests that Dasatinib would be an interesting research target.

FIG. 4A represents a histogram of average accuracy of models in an ensemble of models representing data associated with Dasatinib.

FIG. 4B represents the data from FIG. 4A as a histogram of average accuracy gain of models in an ensemble of models representing data associated with Dasatinib.

FIG. 5A represents the predictability of a type of genomic data set with respect to Dasatinib from an accuracy perspective in histogram form.

FIG. 5B represents the data from FIG. 5A in an accuracy bar chart form for clarity.

FIG. 5C presents the data from FIG. 5A and represent the predictability of a type of genomic data set with respect to Dasatinib from an accuracy gain perspective in histogram form.

FIG. 5D represents the data from FIG. 5C in an accuracy gain bar chart form for clarity.

### DETAILED DESCRIPTION

It should be noted that any language directed to a computer should be read to include any suitable combination of computing devices, including servers, interfaces, systems, databases, agents, peers, engines, controllers, modules, or other types of computing devices operating individually or collectively. One should appreciate the computing devices comprise at least one processor configured to execute software instructions stored on a tangible, non-transitory computer readable storage medium (e.g., hard drive, RAID, NAS, SAN, FPGA, PLA, solid state drive, RAM, flash, ROM, etc.). The software instructions configure or otherwise program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

As used in the description herein and throughout the claims that follow, when a system, engine, server, device, module, or other computing element is described as configured to perform or execute functions on data in a memory, the meaning of “configured to” or “programmed to” is defined as one or more processors or cores of the computing element being programmed by a set of software instructions stored in the memory of the computing element to execute the set of functions or operate on target data or data objects stored in the memory.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, within the context of networked computing devices, the terms “coupled to” and “coupled with” are intended to convey that the devices are able to communicate via their coupling (e.g., wired, wireless, etc.).

One should appreciate that the disclosed techniques provide many advantageous technical effects including coordinating processors to generate trained prediction outcome models based on numerous input training data sets. The memory of the computing system can be distributed across numerous devices and partitioned to store the input training data sets so that all devices are able to work in parallel on generation of an ensemble of models. In some embodiments, the inventive subject matter can be considered as focusing on the construction of a distributed computing system capable of allowing multiple computers to coordinate communication and effort to support a machine learning environment. Still further the technical effect of the disclosed inventive subject matter is considered to include correlating a performance metric of one or more trained model, including an ensemble of trained models, with a target research target. Such correlations are considered to increase likelihood of success of such targets based on hard to interpret data as well as counter possible inherent bias in machine learning model types.

The focus of the disclosed inventive subject matter is to enable construction or configuration of a computing device(s) to operate on vast quantities of digital data, beyond the capabilities of a human. Although the digital data can represent machine-trained computer models of genome and treatment outcomes, it should be appreciated that the digital data is a representation of one or more digital models of such real-world items, not the actual items. Rather, by properly configuring or programming the devices as disclosed herein, through the instantiation of such digital models in the memory of the computing devices, the computing devices are able to manage the digital data or models in a manner that would be beyond the capability of a human. Further, the computing devices lack a priori capabilities without such configuration. The result of creating the disclosed computer-based tools is that the tools provide additional utility to a user of the computing devices that the user would lack without such a tool with respect to gaining evidence-based insight into research areas that might yield beneficial insight or results.

The following disclosure describes a computer-based machine learning system that is configured or programmed to instantiate a large number of trained models that represent mappings from genomic data to possible treatment outcomes under various research circumstances (e.g., drug response, types of data to collect, etc.). The models are trained on vast amounts of data. For example, genomic data from many patients are combined with the treatment outcomes for the same patients in order to create a training data set. The training data sets are fed into one or more model templates; implementations of machine learning algorithms The machine learning system thereby creates corresponding trained models that could be used for predicting possible treatment outcomes based on new genomic data. However, the inventive subject matter focuses on the ensemble trained models rather than predicted outcomes. Beyond predicting possible treatment outcomes, it should be appreciated that the collection of trained models, or rather the ensemble of trained models, can provide insight into which research circumstances or projects might generate the most insightful information as determined by one or more model performance metrics or other characteristics metrics as measured across the ensemble of trained models. Thus, the disclosed system is able to provide recommendations on which research projects might have the most value based on the statistics compiled regarding the ensemble of models rather that than the predicted results of the models.

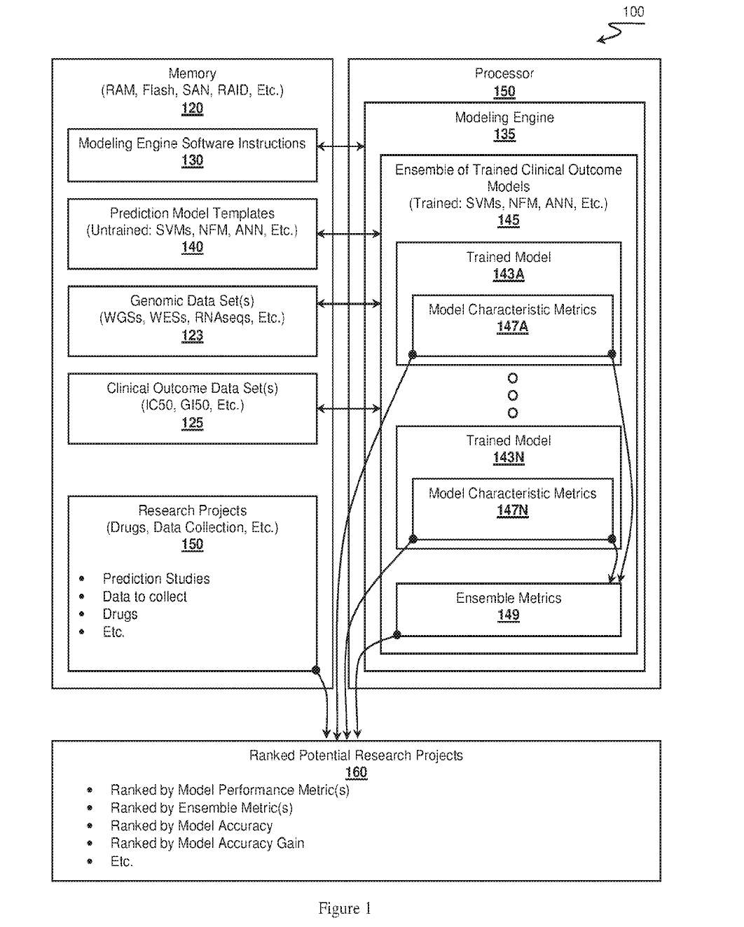

FIG. 1 presents computer-based research project recommendation system 100. Although illustrated as including a single memory and a single processor, it should be appreciated that the memory 120 can include a distributed memory spread over multiple computing devices. Examples of memory 120 can include RAM, flash, SSD, HDD, SAN, NAS, RAID, disk arrays, or other type of non-transitory computer readable media. In a similar vein, although processor 150 is illustrated as a single unit, processor 150 euphemistically represents other processor configurations including single core, multi-core, processor modules (e.g., server blades, etc.), or even networked computer processors. System 100 could be implemented in a distributed computing system, possibly based on Apache® Hadoop. In such a system, the storage devices supporting the Hadoop Distributed File System (HDFS) along with memory of associated networked computers would operate as memory 120. Further, each processor in the computers of the cluster would collectively operate as processor 150. In view that much of the data sets processed by the disclosed system can be quite large (e.g., more than 100 GB in size), the disclosed computing system can leverage such tools as GridEngine, an open-source distributed resource batch processing system for distributing work load among multiple computers. It should be further appreciated that the disclosed system can also operate as a for-fee service implemented in a cloud fashion. Example cloud-based infrastructures that can support such activities include Amazon AWS, Microsoft Azure, Google Cloud, or other types of cloud computing systems. The examples described within this document were generated based on a proprietary workload manager called Pypeline implemented in Python and that leverages the Slurm workload manager (see URL slurm.schedmd.com).

Memory 120 is configured to operate as a storage facility for multiple data sets. One should appreciate that the data sets could be stored on a storage device local to processor 150 or could be stored across multiple storage devices, possibly available to processor 150 over a network (not shown; e.g., LAN, WAN, VPN, Internet, Intranet, etc.). Two data sets of particular interest include genomic data set 123 and clinical outcome data set 125. Both data sets, when combined, form training data that will be used to generate trained models as discussed below.

Genomic data set 123 represents genomic information representative of tissue samples taken from a cohort; a group of breast cancer patients for example. Genomic data set 123 can also include different aspects of genomic information. In some embodiments, genomic data set 123 could include one or more of a the following types of data: a Whole Genome Sequence (WGS), whole exome sequencing (WES) data, microarray expression data, microarray copy number data, PARADIGM data, SNP data, RNAseq data, protein microarray data, exome sequence data, or other types of genomic data. As an example, genomic data 123 could include WGS for breast cancer tumors from more than 100, 1000, or more patients. Genomic data set 123 could further include genomic information associated with healthy tissues as well, thus genomic data set 123 could include information about diseased tissue with a matched normal. Numerous file formats can be used to store genomic data set 123 including VCF, SAM, BAM, GAR, BAMBAM, just to name a few. Creation and use of PARADIGM and pathway models are described in U.S. patent application publication US2012/0041683 to Vaske et al. titled “Pathway Recognition Algorithm Using Data Integration on Genomic Models (PARADIGM)”, filed Apr. 29, 2011; U.S. patent application publication US2012/0158391 to Vaske et al. titled “Pathway Recognition Algorithm Using Data Integration on Genomic Models (PARADIGM)”, filed Oct. 26, 2011; and international patent application publication WO 2014/193982 to Benz et al. titled “PARADIGM Drug Response Network”, filed May 28, 2014. BAMBAM technologies are described in U.S. published patent applications 2012/0059670 titled “BAMBAM: Parallel Comparative Analysis of High-Throughput Sequencing Data”, filed May 25, 2011; and 2012/0066001 titled “BAMBAM: Parallel Comparative Analysis of High-Throughput Sequencing Data”, filed Nov. 18, 2011.

Clinical outcome data set 125 is also associated with the cohort and is representative of measured clinical outcomes of the cohort's tissue samples after a treatment; after administering a new drug for example. Clinical outcome data set 125 could also include data from numerous patients within the cohort and can be indexed by a patient identifier to ensure a patient's outcome data in clinical outcome data set 125 is properly synchronized with the same patient's genomic data in genomic data set 123. Just as there are numerous different types of genomic data that can compose genomic data sets 123, there are also numerous types of clinical outcome data sets. For example, clinical outcome data set 125 could include drug response data, survival data, or other types of outcome data. In some embodiments, the drug response data could include IC50 data, GI50 data, Amax data, ACarea data, Filters ACarea data, max dose data, or more. Further, the clinical outcome data set might include drug response data from 100, 150, 200, or more drugs that were applied across numerous clinical trials. As a more specific example, the protein data could include MDA RPPA Core platform from MD Anderson.

Each of data sets, among other facets of the data, represents aspects of a clinical or research project. With respect to genomic data set 123, the nature or type of data that was collected represents a parameter of a corresponding research project. Similarly, with respect to clinical outcome data set 125 corresponding research project parameters could include type of drug response data to collected (e.g., IC50, GI50, etc.), drug under study, or other parameters or attributes related to corresponding research projects. The reader's attention is called to these factors because such factors become possible areas of future focus. These factors can be analyzed with respect to ensemble statistics once an ensemble of trained models are generated in order gain insight into which of the factors offer possible opportunities.

In the example shown in FIG. 1, research projects 150 stored in memory 120 represent data constructs or record objects representing aspects of potential research. In some embodiments, research projects 150 can be defined based on set of attribute-value pairs. The attribute-value pairs can adhere to a namespace that describes potential research projects and that share parameters or attributes with genomic data sets 123 or clinical outcome data sets 125. Leveraging a common namespace among the data sets provides for creating possible correlations among the data sets. Further, research projects 150 can also include attribute-value pairs that can be considered metadata, which does not directly relate to the actual nature of the data collected, but rather relate more directly to a research task or prediction task at least tangentially associated with the data sets. Examples of research task metadata could include costs to collect data, predication studies, researcher, grant information, or other research project information. With respect to prediction studies for which models can be built, the prediction studies can include a broad spectrum of studies including drug response studies, genome expression studies, survivability studies, subtype analysis studies, subtype difference studies, molecular subtype studies, disease state studies, or other types of studies. It should be appreciated that the disclosed approach provides for connecting the nature of the input training data to the nature of potential research projects via their shared or bridging attributes.

Memory 120, or a portion of memory 120, can also include one or more of prediction model templates 140. Prediction model templates 140 represent untrained or “blank” model that have yet to take on specific features and represent implementations of corresponding algorithms One example of a model template could include a Support Vector Machine (SVM) classifier stored as a SVM library or executable module. When system 100 leverages genomic data sets 123 and clinical outcome data sets 125 to train the SVM model, system 100 can be considered as instantiating a trained, or even fully trained, SVM model based on the known genomic data set 123 and known outcome data set 125. The configuration parameters for the fully trained model can then be stored in memory 120 as an instance of the trained model. The configuration parameters will vary from model type to model type, but can be considered a compilation of factor weights. In some embodiments, prediction model templates 140 includes at least five different types of models, at least 10 different types of models, or even more than 15 different types of models. Example types of models can include linear regression model templates, clustering model templates, classifier models, unsupervised model templates, artificial neural network templates, or even semi-supervised model templates.

A source for at least some of prediction model templates 140 includes those available via scikit-learn (see URL www.scikit-learn.org), which includes many different model templates, including various classifiers. The types of classifiers can be also be quite board and can include one or more of a linear classifier, an NMF-based classifier, a graphical-based classifier, a tree-based classifier, a Bayesian-based classifier, a rules-based classifier, a net-based classifier, a kNN classifier, or other type of classifier. More specific examples include NMFpredictor (linear), SVMlight (linear), SVMlight first order polynomial kernel (degree-d polynomial), SVMlight second order polynomial kernel (degree-d polynomial), WEKA SMO (linear), WEKA j48 trees (trees-based), WEKA hyper pipes (distribution-based), WEKA random forests (trees-based), WEKA naive Bayes (probabilistic/bayes), WEKA JRip (rules-based), glmnet lasso (sparse linear), glmnet ridge regression (sparse linear), glmnet elastic nets (sparse linear), artificial neural networks (e.g., ANN, RNN, CNN, etc.) among others. Additional sources for prediction model templates 140 include Microsoft's CNTK (see URL github.com/Microsoft/cntk), TensorFlow (see URL www.tensorflow.com), PyBrain (see URL pybrain.org), or other sources.

One should appreciate that each type of model includes inherent biases or assumptions, which can influence how a resulting trained model would operate relative to other types of trained models, even when trained on identical data. The inventors have appreciated that leveraging as many reasonable models as available aids in reducing exposure to such assumptions or to biases when selecting models. Therefore, the inventive subject matter is considered to include using ten or more types of model templates, especially with respect to research subject matter that could be sensitive to model template assumptions.

Memory 120, or portion of memory 120, can also include modeling engine software instructions 130 that represent one or more of modeling computer or engine 135 executable on one or more of processor 150. Modeling engine 135 has the responsibility for generating many trained prediction outcome models from prediction model templates 140. As a basic example, consider a scenario where prediction model templates includes two types of models; an SVM classifier and an NMFpredictor (see U.S. provisional application 61/919,289 filed Dec. 20, 2013 and corresponding international application WO 2014/193982 filed May 28, 2014). Now consider that the genomic data set 123 and clinical outcome data set 125 represent data from 150 drugs. Modeling engine 135 uses the cohort data sets to generate a set of trained SVM models for all 150 drugs as well as a set of trained NMFpredictor models for all 150 drugs. Thus, from the two model templates, modeling engine 135 would generate or otherwise instantiate 300 trained prediction models. An example of modeling engine 135 includes those described in International published patent application WO 2014/193982 titled “Paradigm Drug Response Network”, filed May 28, 2014.

Modeling engine 135 configures processor 150 to operate as a model generator and analysis system. Modeling engine 135 obtains one or more of prediction model templates 140. In the example shown, prediction model templates 140 are already present in memory 120. However, in other embodiments, prediction model templates 140 could be obtained via an application program interface (API), through which a corresponding set of modules or library are accessed, possibly based on a web service. In other embodiments, a user could place available prediction model templates 140 into a repository (e.g., database, file system, directory, etc.) via which modeling engine 135 can access the templates by reading or importing the files, and/or querying the database. This approach is considered advantageous because it provides for an ever increasing number of prediction model templates as time progresses forward. Further, each template can be annotated with metadata indicating its underlying nature; the assumptions made by the corresponding algorithms, best uses, instructions, or other data. The model templates can then be indexed according to their metadata in order to allow researchers to select which models might be most appropriate for their work by selecting models having metadata that satisfy the research projects (e.g., respond study, data to collect, prediction tasks, etc.) selection criteria. Typically, it is expected the nearly all, if not all, of the model templates will be used in building an ensemble.

Modeling engine 135 further continues by generating an ensemble of trained clinical outcome prediction models as represented by trained model 143A through 143N, collectively referred to as trained models 143. Each model also includes characteristics metrics 147A and 147N, collectively referred to as metrics 147. Modeling engine 135 instantiates trained models 143 by using predication model templates 140 and training the templates on genomic data sets 123 (e.g., initial known data) and on clinical outcome data sets 125 (e.g., final known data). Trained models 143 represent prediction models that could be used, if desired, in a clinical setting for personalized treatment or prediction outcomes by running a specific patient's genomic data through the trained models in order to generate a predicted outcome. However, there are two points of note. First, the focus of the inventive subject matter of this document is on the ensemble of models as a whole rather than just a predicted outcome. Second, the ensemble of trained models 143 can include evaluation models, beyond just fully trained models, that are trained on only portions of the data sets, while a fully trained model would be trained on the complete data set. Evaluation models aid in indicating if a fully trained model would or might have value. In some sense, evaluation models can be considered partially trained models generated during cross-fold validations.

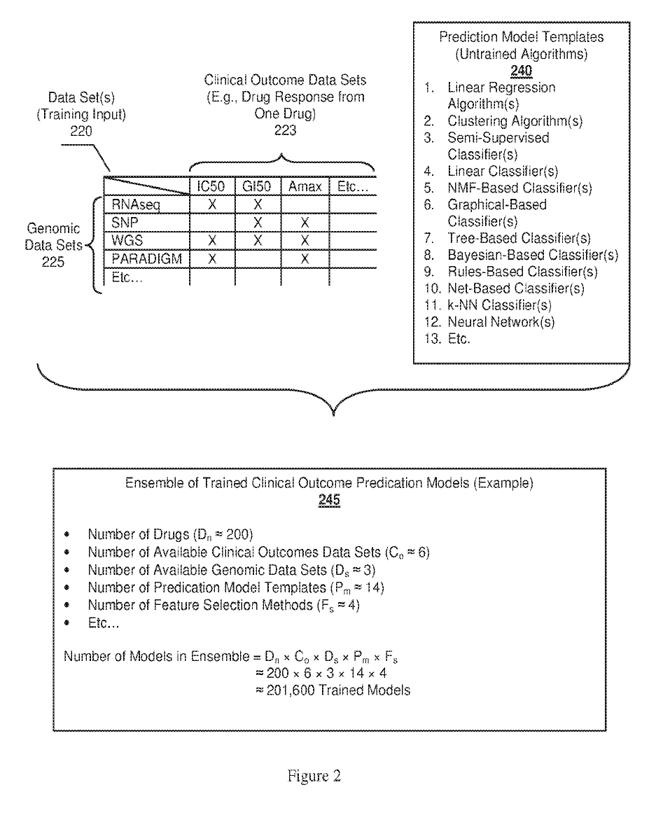

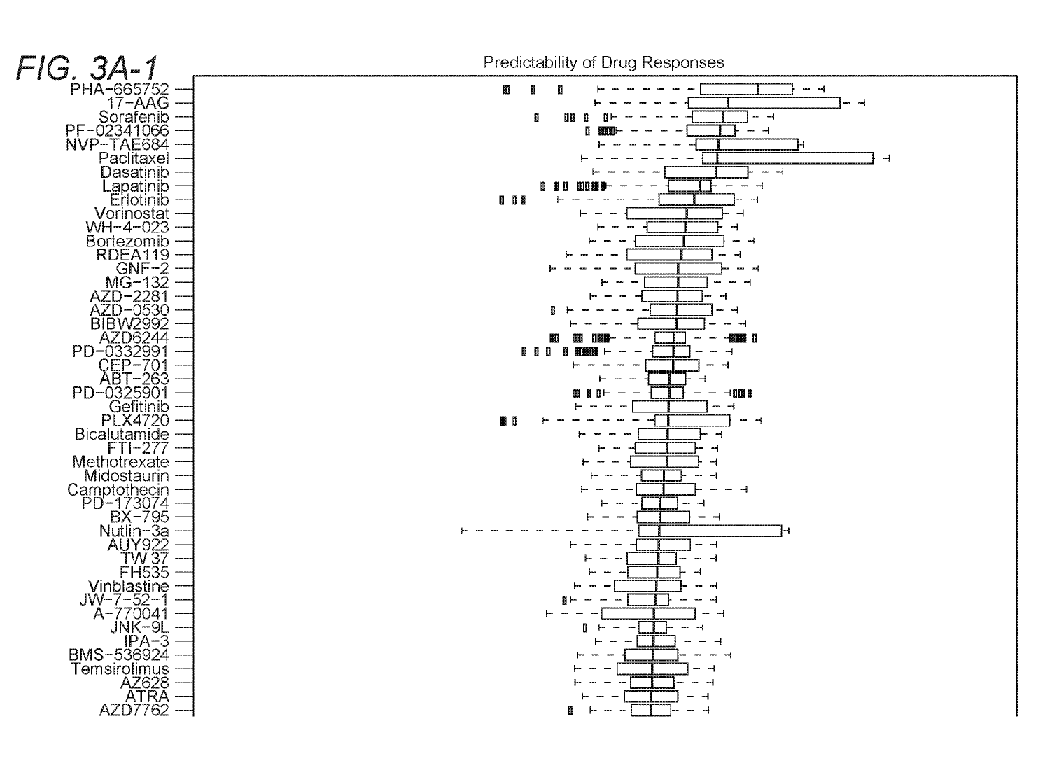

Although FIG. 1 illustrates only two trained models 143, one should appreciate that the number of trained models could include more than 10,000; 100,000; 200,000; or even more than 1,000,000 trained models. In fact, in some implementations, an ensemble has included more than 2,000,000 trained models. In some embodiments, depending on the nature of the data sets, trained models 143 could comprise an ensemble of trained clinical outcome models 145 that has over 200,000 fully trained models as discussed with respect to FIG. 2.

Each of trained models 143 can also include model characteristic metrics 147, presented by metrics 147A and 147N with respect to their corresponding trained models. Model characteristic metrics 147 represent the nature or capability of the corresponding trained model 143. Example characteristic metrics can include an accuracy, an accuracy gain, a performance metric, or other measure of the corresponding model. Additional example performance metrics could include an area under curve metric, an R², a p-value metric, a silhouette coefficient, a confusion matrix, or other metric that relates to the nature of the model or its corresponding model template. For example, cluster-based model templates might have a silhouette coefficient while an SVM classifier trained model does not. The SVM classifier trained model might use AUC or p-value for example. One should appreciate that the characteristics metrics 147 are not considered outputs of the model itself. Rather, model characteristics metrics 147 represent the nature of the trained model; how accurate are its predictions based on the training data sets for example. Further, model characteristic metrics 147 could also include other types of attributes and associated values beyond performance metrics. Additional attributes that can be used at metrics relating to trained models 143 include source of the model templates, model template identifier, assumptions of the model templates, version number, user identifier, feature selection, genomic training data attributes, patient identifier, drug information, outcome training data attributes, timestamps, or other types of attributes. Model characteristics metrics 147 could be represented as an n-tuple or vector of values to enable easy portability, manipulation, or other type of management or analysis as discussed below. Thus, each model can include information about its source and can therefore include attributes associated with the same namespace associated with genomic data set 123, clinical outcome data set 125, and research projects 150. Both trained models 143 and corresponding model characteristics metrics 147 can be stored on memory 120 as final trained model instances, possibly based on a JSON, YAML, or XML format. Thus, the trained models can be archived and retrieved at a later date.

Not only are individual model characteristic metrics 147 available for each individual trained model 143A through 143N, modeling engine 135 can also generate ensemble metrics 149 that represent attributes of the ensemble of trained clinical outcome models 145. Ensemble metrics 149 could, for example, comprises an accuracy distribute or accuracy gain distribution across all models in the ensemble. Additionally, ensemble metrics 149 could include the number of models in the ensemble, ensemble performance, ensemble owner(s), distribute of which model types are within the ensemble, power consumed to create ensemble, power consumed per model, cost per model, or other information relating to the ensemble in general.

Accuracy of a model can be derived through use of evaluation models built from the known genomic data sets and corresponding known clinical outcome data sets. For a specific model template, modeling engine 135 can build a number of evaluation models that are both trained and validated against the input known data sets. For example, a trained evaluation model can be trained based on 80% of the input data. Once the evaluation model has been trained, the remaining 20% of the genomic data can be run through the evaluation model to see if it generates prediction data similar to or closet to the remaining 20% of the known clinical outcome data. The accuracy of the trained evaluation model is then considered to be the ratio of the number of correct predictions to the total number of outcomes. Evaluation models can be trained using one or more cross-fold validation techniques.

Consider a scenario where genomic data set 123 and clinical outcome data set 125 represent a cohort of 500 patients. Modeling engine 135 can partition the data sets into one or more groups of evaluation training sets, say containing 400 patient samples. Modeling engine creates trained evaluation model based on the 400 patient samples. The trained evaluation model can then be validated by executing the trained evaluation model on the remaining 100 patients' genomic data set to generate 100 prediction outcomes. The 100 prediction outcomes are then compared to the actual 100 outcomes from the patient data in clinical outcome data set 125. The accuracy of the trained evaluation model is the number of correct prediction outcomes (i.e., true positives and true negatives) relative to the total number of outcomes. If, out of the 100 prediction outcomes, the trained evaluation model generates 85 correct outcomes that match the actual or known clinical outcomes from the patient data, then the accuracy of the trained evaluation model is considered 85%. The remaining 15 incorrect outcomes would be considered false positives and false negatives.

It should be appreciated that modeling engine 135 can generated numerous trained evaluation models for a specific instance of cohort data and model template simply by changing how the cohort data is portioned between training samples and validation systems. For example, some embodiments can leverage 5×3 cross-fold validations, which would result in 15 evaluation models. Each of the 15 trained evaluation models would have its own accuracy measure (e.g., number of right predictions relative to the total number). Assuming that accuracies from the evaluation models indicate that the collection of models are useful (e.g., above threshold of chance, above the majority classifier, etc.), a fully trained model can be built based on 100% of the data. This means the total collection of models for one algorithm would include one fully trained model and 15 evaluation models. The accuracy of the fully trained model would then be considered an average of its trained evaluation models. Thus, the accuracy of a fully trained model could include the average, the spread, the number of corresponding trained models in the ensemble, the max accuracy, the min accuracy, or other measure from the statistics of the trained evaluation models. Research projects can then be ranked based on the accuracy of related fully trained models.

Another metric related to accuracy includes accuracy gain. Accuracy gain can be defined as the arithmetical difference between a model's accuracy and the accuracy of a “majority classifier”. The resulting metric can be positive or negative. Accuracy gain can be considered a model's performance relative to chance with respect to the known possible outcomes. The higher (more positive) the accuracy gain of a model, the more information it is able to provide or learn from the training data. The lower (more negative) the accuracy gain of a model, the less relevance the model has because it is not able to provide insights beyond chance. In a similar vein to accuracy, accuracy gain for a fully trained model can comprise a distribution of accuracy gains from the evaluation models. Thus, a fully trained model's accuracy gain could include an average, a spread, a min, a max, or other value. In a statistical sense, a highly interesting research project would most likely have a high accuracy gain with a distribution of accuracy gain above zero.

In view that models within ensemble of trained clinical outcome models 145 carry attribute or metric information associated with the nature of the data used to create the model or with the source of the model, modeling engine 135 can correlate information about the ensemble with research projects 150 having similar attributes. Thus modeling engine 135 can generate a ranked listing, ranked potential research projects 160 for example, of potential research projects from research projects 150 according to ranking criteria that depends on the model characteristics metrics 147 or even ensemble metrics 149. Consider a situation where the ensemble includes trained model 143 for over 100 drug response studies. Modeling engine 135 can rank the drug response studies by the accuracy or accuracy gain of each study's corresponding models. The ranked listing could comprise a ranked set of drug responses, drugs, type of genomic data collection, types of drug response data collected, prediction tasks, gene expressions, clinical questions (e.g., survivability, etc.), outcome statistics, or other type of research topic.

Once modeling engine 135 compiles ranked potential research projects 160, modeling engine 135 can cause a device (e.g., cell phone, tablet, computer, web server, etc.) to present the ranked listing to a stakeholder. The ranked listing essentially represents recommendations on which projects, tasks, topics, or areas are considered to be most insightful based on the nature of models or how the models in aggregate where able to learn. For example, an ensemble's accuracy gain can be considered a measure of which modeled areas provided the most informational insight. Such areas would be considered as candidates for research dollars or diagnostic efforts as evidenced by trained models generated from known, real-world genomic data set 123 and corresponding known, real-world clinical outcome data set 125.

FIG. 2 provides additional details regarding generation of an ensemble of trained clinical outcome prediction models 245. In the example shown, the modeling engine obtains training data represented by data sets 220 that includes known genomic data sets 225 and known clinical outcome data sets 223. In this example, data sets 220 include data representative of a drug response study associated with a single drug. However, data sets from multiple drugs could be included in the training data sets; more than 100 drugs, 150 drugs, 200 drugs, or more. Further, the modeling engine can obtain one or more of prediction model templates 240 that represent untrained machine learning modules. Leveraging multiple types of model templates aids in reducing exposure to the underlying assumption of each individual template and aids in eliminating researcher bias because all relevant templates or algorithms are used.

The modeling engine uses the training data set to generate many trained models from model templates 240 where the trained models form ensemble of trained clinical outcome prediction models 245. Ensemble of models 245 can include an extensive number of trained modules. In the example shown, consider a scenario where a researcher has access to training data associated with 200 drugs. The training data for each drug could include six types of known clinical outcome data (e.g., IC50 data, GI50 data, Amax data, ACarea data, Filtered ACarea data, and max dose data), and three types of known genomic data sets (e.g., WGS, RNAseq, protein expression data). If there are four feature selection methods and about 14 different types of models, then the modeling engine could create over 200,000 trained models in the ensemble; one model for each possible configuration parameters.

Each of the individual models in ensemble of models 245 further comprises metadata describing the nature of the models. As discussed previously, the metadata can include performance metrics, types data used to train the models, features used to train the models, or other information that could be considered as attributes and corresponding values in a research project namespace. This approach provides for selecting groups of models that satisfy selection criteria that depend on the attributes of the namespace. For example, one could select all models trained according to collected WGS data, or all models trained on data relating to a specific drug. Individual models can be stored in a storage device depending on the nature of their underlying template; possibly in a JSON, YAML, or XML file storing specific values of the trained model's coefficients or other parameters along with associated attributes, performance metrics, or other metadata. When necessary or desired, the model can be re-instantiated by simply reading the corresponding file's model trained values or weights, then setting the corresponding template's parameters to the read values.

Once ensemble of models 245 is formed or generated, the performance metrics or other attributes can be used to generate a ranked listing of potential research projects. Consider a scenario where over 200,000 models have been generated. A clinician selects models relating to a drug response study of a specific drug, which might result in about 1000 to 5000 selected models. The modeling engine could then use the performance metrics (e.g., accuracy, accuracy gain, etc.) of the selected models to rank types of genomic data to collect (e.g., WGS, expression, RNAseq, etc.). This would be achieved by the modeling engine partitioning the models into result sets according to the type of genomic data collected. The selected performance metrics (or other attribute values) for each result set can be calculated; average accuracy gain for example. Thus, each result set can be ranked based on their corresponding calculated models' performance metrics. In the current example, each type of genomic data to collect could be ranked according to average accuracy gain of the corresponding models. Such a ranking provides insight to the clinician on which type of genomic data would likely be best to collect for a patient given the specified drug because the nature of the models suggests where the model information is likely most insightful. In some embodiments, the ranking suggests what type of genomic data to collect, possibly including microarray expression data, microarray copy number data, PARADIGM data, SNP data, whole genome sequencing (WGS) data, whole exome sequencing data, RNAseq data, protein microarray data, or other types of data. The ranked listing can also be ranked by a secondary or even tertiary metrics. Cost of a type of data to collect and/or time to process the corresponding data would be two examples. This approach allows a researcher to determine the best course of action for the target research topic or project because the researcher can see which topic or project configuration is likely to provide the greatest insight based on the ensemble's metrics.

Yet another example could include ranking drug responses by model metrics. In such a case, the ranked drug response studies yields insight into which areas of drug response or compounds might be of most interest as target research projects to purse. Still further, the rankings can suggest which types of clinical outcome data to collect, possibly including IC50 data, GI50 data, Amax data, ACarea data, Filtered ACarea data, max dose data, or other type of outcome data. Yet even further, the rankings can suggest which types of prediction studies might be of most interest, perhaps including one or more of a drug response study, a genome expression study, a survivability study, a subtype analysis study, a subtype differences study, a molecular subtypes study, a disease state study, or other studies.

The following figures represent rankings of various research topics based on accuracy or accuracy gain performance metrics from an ensemble of over 100,000 trained models that are trained on real-world, known genomic data sets and their corresponding known clinical outcome data sets. These results in the following figures are real-world examples generated by the Applicants based on real-world data obtained from Broad Institute's Cancer Cell Line Encyclopedia (CCLE; see URL www.broadinstitute.org/ccle/home), and the Sanger Institute's Cancer Genome Project (CGP; see URL www.sanger.ac.uk/science/groups/cancer-genome-project).

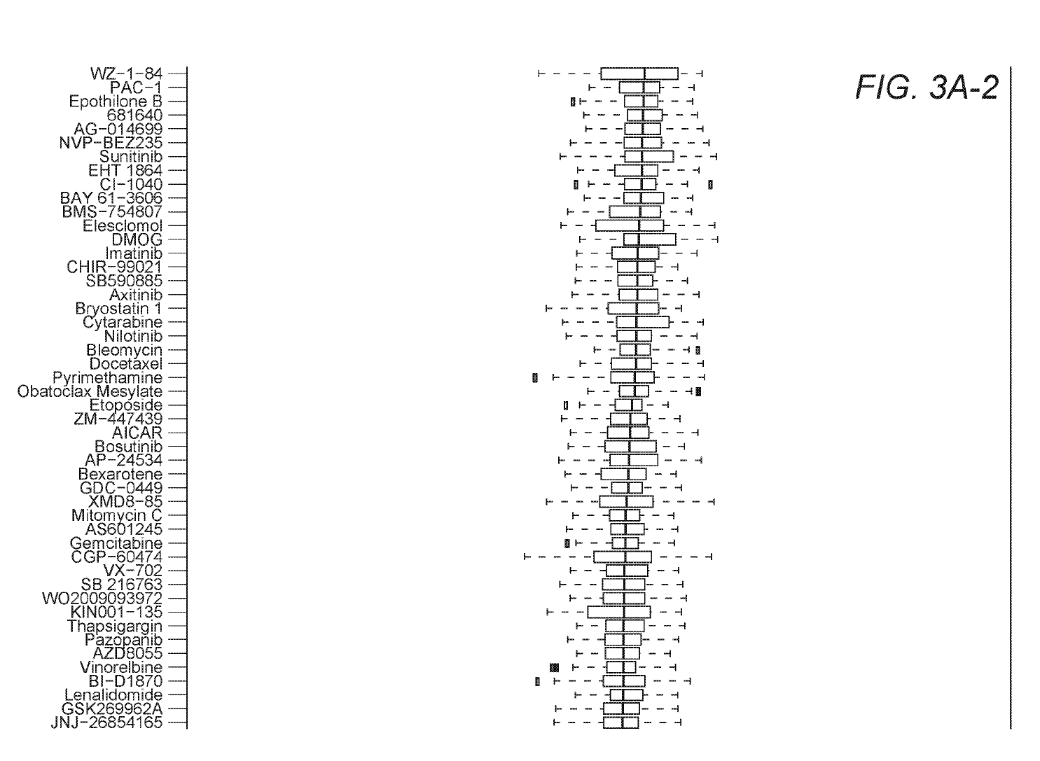

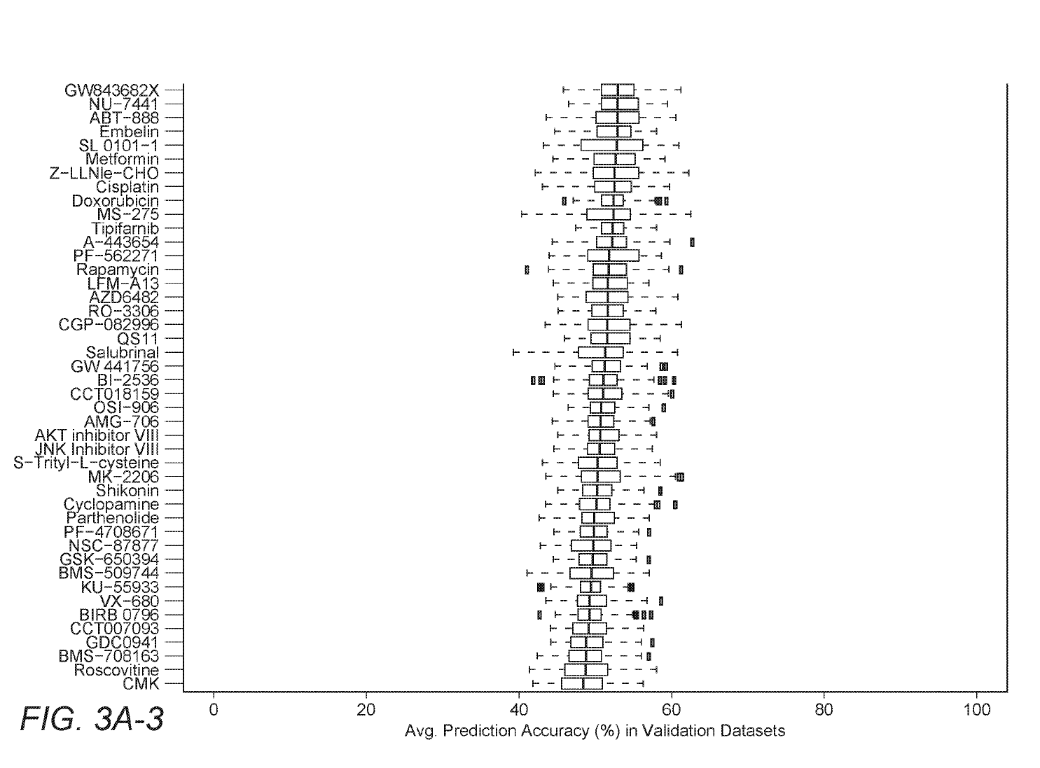

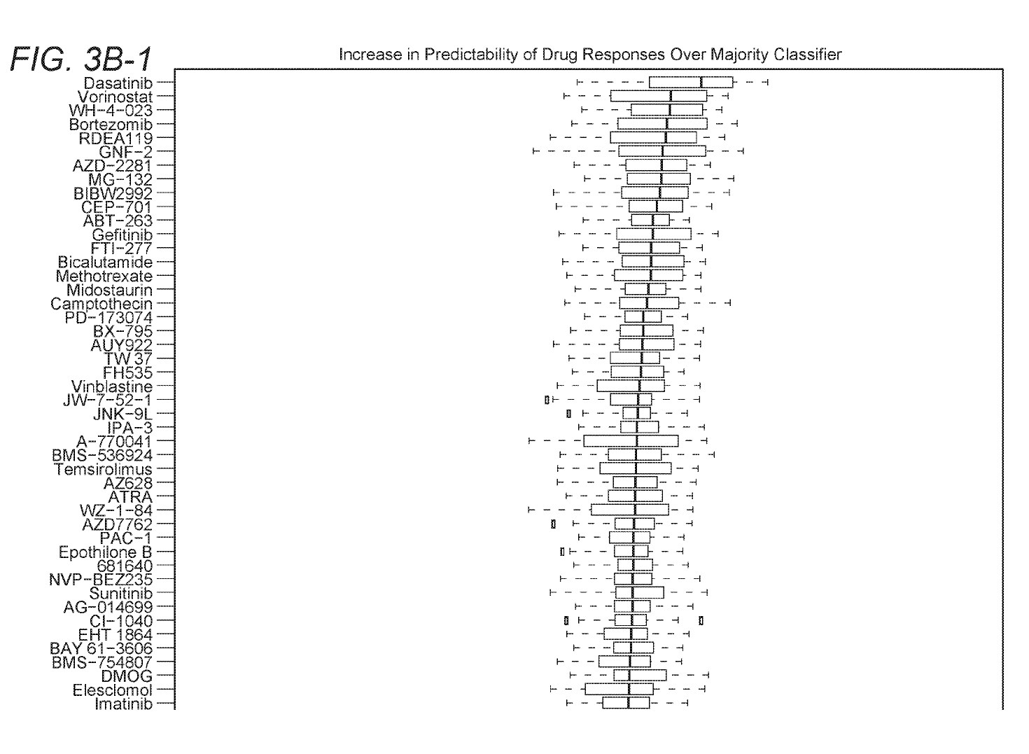

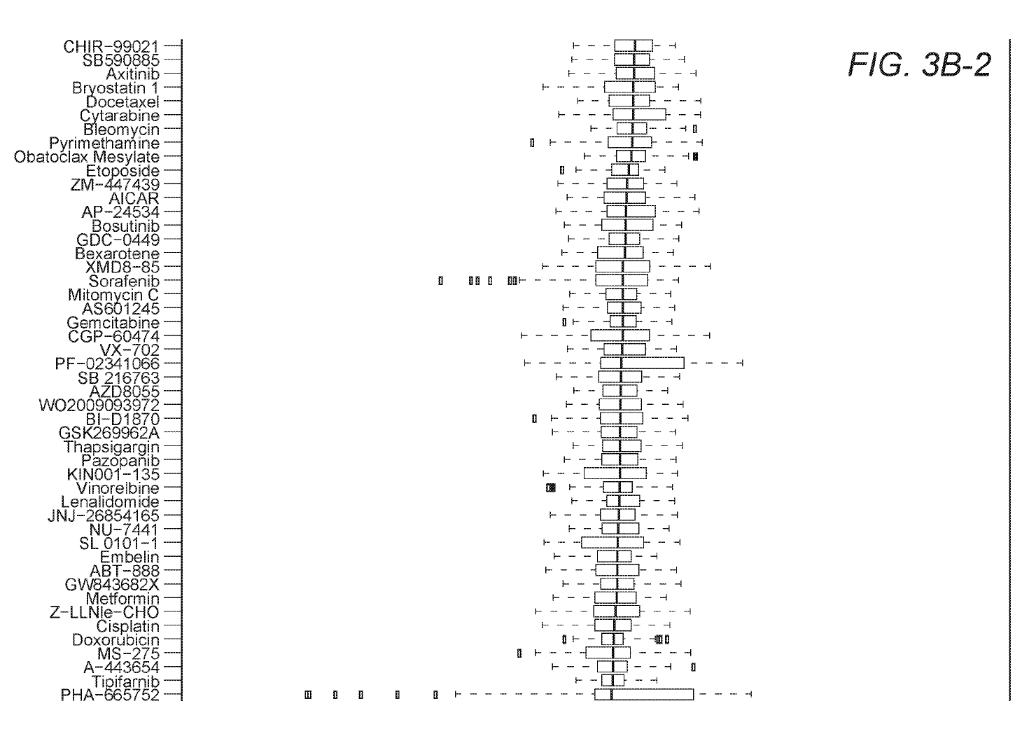

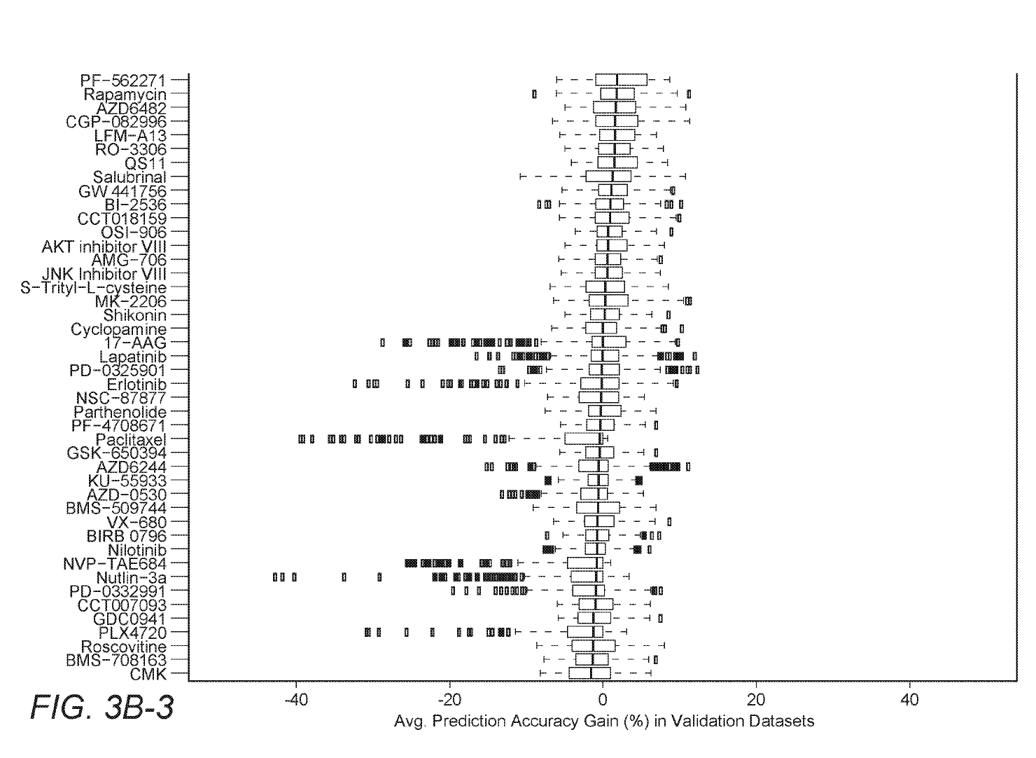

FIG. 3A includes real-world data associated with numerous drug response studies and represents the predictability of the drug responses as determined by the average accuracy of models generated from validation data sets corresponding to the drugs. Based on accuracy alone, the data suggests that PHA-665752, a small molecule c-Met inhibitor, would likely be a candidate for further study because the ensemble of models indicates there is substantial information to be learned from data related to PHA-664752 because the average accuracy for all trained models is highest. The decision to pursue such a candidate can be balanced by other metrics or factors including costs, accuracy gain, time, or parameters. One should appreciate that the distribution shown represents the accuracy values spread across numerous fully trained models rather than evaluation models. Still, the researcher could interact with the modeling engine to drill down to the one or more evaluation models, and their corresponding metrics or metadata if desired.

The reader's attention is directed to Dasatinib, which is ranked 7^{th} in FIG. 3A. FIG. 3B represents the same data from FIG. 3A. However, the drugs have been ranked by accuracy gain. In this case, PHA-665752 drops to the middle of the pack, with an average accuracy gain around zero. However, Dasatinib, a tyrosine kinase inhibitor, moves from 7^{th} rank to 1^{st} rank with an average accuracy gain much greater than zero; about 15%. This data suggests that Dasatinib would likely be a better candidate for further resource allocation in view the ensemble of models yield high accuracy as well as high accuracy gain.

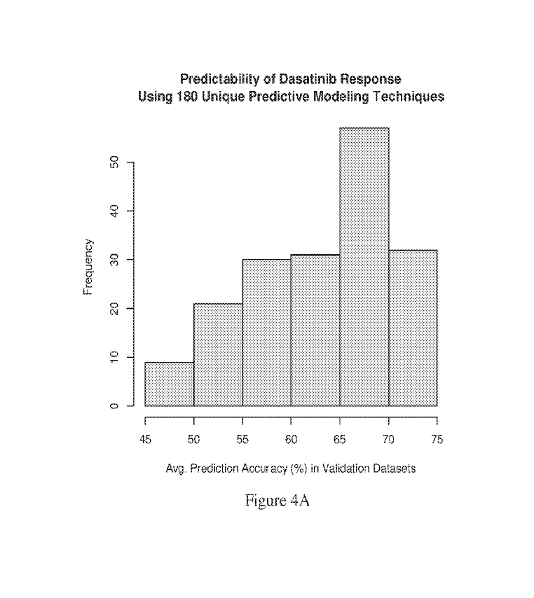

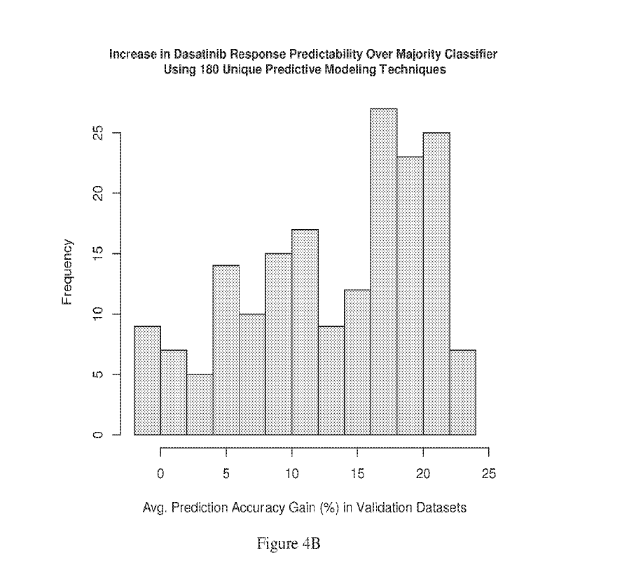

FIG. 4A provides further clarity with respect to how metrics from an ensemble of models might behave. FIG. 4A is a histogram of the average accuracy for models within the Dasatinib ensemble of models. Note that the mode is relatively high, indicating that Dasatinib might be a favorable candidate for application of additional resources. In other words, the 180 models associated with Dasatinib indicate that the models in aggregate learned well on average.

FIG. 4B presents the same data from FIG. 4A in the form of a histogram of average accuracy gain from the Dasatinib ensemble of models. Again, note the mode is relatively high, around 20%, with a small number of models below zero. This disclosed approach of ranking drug response studies or drugs according to model metrics is considered advantageous because it provided an evidenced-based indication on where Pharma companies should direct resources based on how well data can be leveraged for learning.

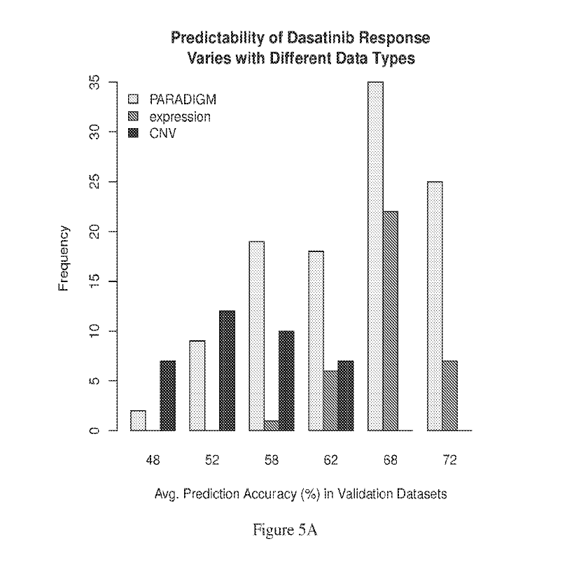

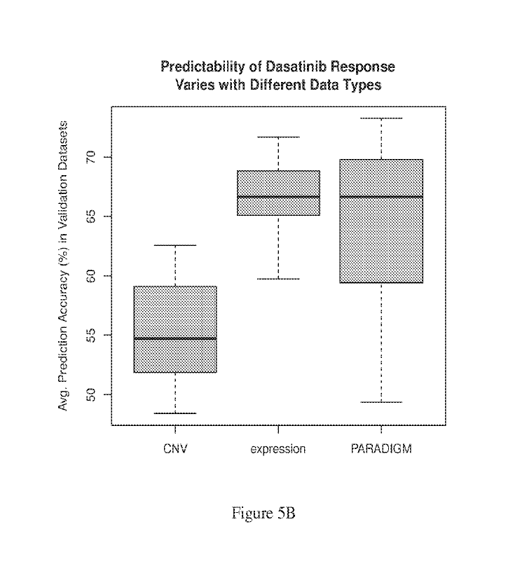

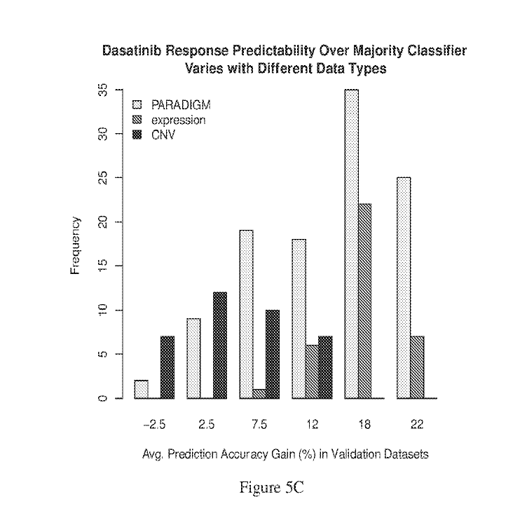

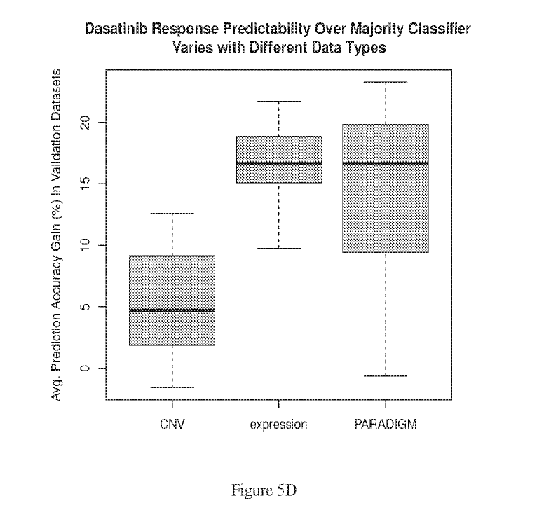

Continuing with a drill down on Dasatinib, FIG. 5A illustrates how predictive a type of genomic data (e.g., PARADIGM, expression, CNV—Copy Number Variation, etc.) is with respect to model accuracy. The data suggests that PARADIGM and expression data is more useful than CNV. Thus, a clinician might suggest that it would make more sense to collect PARADIGM or expression data for a patient under treatment with Dasatinib over collection CNV; subject to cost, time, or other factors.

FIG. 5B presents the same data from FIG. 5A in a more compact form as a bar chart. This chart clarifies that the expression data would likely be the best type of data to collect because it yields high accuracy and consistent (i.e., tight spread) models.

FIG. 5C illustrates the same data from FIG. 5A except with respect to accuracy gain in a histogram form. Further clarity is provided by FIG. 5D where the accuracy gain data is presented in a bar chart, which reinforces that expression data is likely the most useful data to collect with respect to Dasatinib.

The example embodiments provided above reflect data from specific drug studies where the data represents an initial state (e.g., copy number variation, expression data, etc.) to a final state (e.g., responsiveness to a drug). In the examples presented, the final stage remains the same; a treatment outcome. However, it should be appreciated that the disclosed techniques can be applied equally to any two different states associated with the patient data rather than just treatment outcome. For example, rather than training the ensemble of models on just WGS and treatment outcome, one could train the ensembles on WGS and intermediary biological process states or immunological states, protein expression for example. Thus, the inventive subject matter is also considered to include building ensembles of models from data sets that reflect a finer state granularity than requiring just a treatment outcome. More specifically patient data representing numerous biological states can be collected from actual DNA sequences up through macroscopic effect, such as treatment outcome. Contemplated biological state information can include gene sequences, mutations (e.g., single nucleotide polymorphism, copy number variation, etc.), RNAseq, RNA, mRNA, miRNA, siRNA, shRNA, tRNA, gene expression, loss of heterozygosity, protein expression, methylation, intra-cellular interactions, inter-cellular activity, images of samples, receptor activity, checkpoint activity, inhibitor activity, T-cell activity, B-cell activity, natural killer cell activity, tissue interactions, tumor state (e.g., reduction in size, no change, growth, etc.) and so on. Any two of these among other could be the basis building training data sets. In some embodiments, semi-supervised or unsupervised learning algorithms (e.g., k-means clustering, etc.) can be leveraged when the data fails to fall cleaning into well-defined classes. Suitable sources of data can be obtained from The Cancer Genome Atlas (see URL tcga-data.nci.nih.gov/tcga).

Data from each biological state (i.e., an initial state) can be compared to data from another, later biological state (i.e., final state) by building corresponding ensembles of models. This approach is considered advantageous because it provides deeper insight into where causal effects would likely give rise to observed correlations. Further, such a fine grained approach also provides for building a temporal understanding of which states are most amenable to study based on the ensemble learning observations. From a different perspective, building ensembles of models for any two states can be considered as providing opportunities for discovery by creating higher visibility into possible correlations among the states. It should be appreciated that such visibility is based on more than merely observing a correlation. Rather, the visibility and/or discovery is evidenced by the performance metrics of the corresponding ensembles as discussed previously.

Consider a scenario where gene mutations studied with respect to treatment outcome. It is possible that, for a specific drug, the ensemble of models might lack evidence of any significant learning for the specific genes when compared to treatment outcome. If the data analysis stops there, no further insight is gained. Leveraging the disclosed fine grained approach one could collect data at many different biological states, possibly including protein expression or T-cell checkpoint inhibitor activity. These two states could be analyzed to reveal, when a specific drug is present, the protein expression and the T-cell checkpoint inhibitor activity are not only correlated, but also are highly amendable to machine learning with high accuracy gain. Such an insight would indicate that further study might be warranted with respect to these correlations than with respect to gene mutation.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A clinical research project machine learning computer system comprising:
at least one processor;
at least one memory coupled with the processor and configured to store:
a genomic data set representative of tissue samples taken from a cohort;
a clinical outcome data set associated with the cohort and representative of clinical outcomes of the tissue samples after a treatment; and
wherein the genomic data set and the clinical outcome data are related to a plurality of potential research projects; and
at least one modeling engine executable on the at last one processor according to software instructions stored in the at least one memory, and that configures the processor to:
obtain a set of prediction model templates;
generate an ensemble of trained clinical outcome prediction models based on the set of prediction model templates and as a function of the genomic data set and the clinical outcome data set, wherein each trained clinical outcome prediction model comprises model characteristic metrics that represent attributes of the corresponding trained clinical outcome prediction model;
generate a ranked listing of potential research projects selected from the of the plurality of potential research projects according to ranking criteria depending on the prediction model characteristic metrics of the plurality of trained clinical outcome prediction models; and
cause a device to present the ranked listing of the potential research projects.

2. The system of claim 1, wherein the set of prediction model templates includes at least ten prediction model types.

3. The system of claim 1, wherein the set of prediction model templates comprise at least one of an implementation of a linear regression algorithm, a clustering algorithm, and an artificial neural network.

4. The system of claim 1, wherein the set of prediction model templates comprise at least one of an implementation of a classifier algorithm.

5. The system of claim 4, wherein the at least one of the implementation of the classifier algorithm represents a semi-supervised classifier.

6. The system of claim 4, wherein the at least one of the implementation of the classifier algorithm represents at least one of the following types of classifiers: a linear classifier, an NMF-based classifier, a graphical-based classifier, a tree-based classifier, a Bayesian-based classifier, a rules-based classifier, a net-based classifier, and a kNN classifier.

7. The system of claim 1, wherein the model characteristic metrics include a model accuracy measure.

8. The system of claim 6, wherein the model accuracy measure comprises a model accuracy gain.

9. The system of claim 1, wherein the model characteristic metrics include at least one of the following model performance metrics: an area under curve (AUC) metric, an R² metric, a p-value, and a silhouette coefficient.

10. The system of claim 1, wherein the ranking criteria are defined according to ensemble metrics derived from the model characteristic metrics.

11. The system of claim 1, wherein the ensemble of trained clinical outcome prediction models includes at least one fully trained clinical outcome prediction model that is trained on a complete cohort data set that is selected from the genomic data set and the clinical outcome data set.

12. The system of claim 1, wherein the clinical outcome data includes drug response outcome data.

13. The system of claim 12, wherein the drug response outcome data includes at least one of the following with respect to the plurality of drugs: IC50 data, GI50 data, Amax data, ACarea data, Filtered ACarea data, and max dose data.

14. The system of claim 12, wherein the drug response outcome data includes data for at least 100 drugs.

15. The system of claim 14, wherein the drug response outcome data includes data for at least 150 drugs

16. The system of claim 15, wherein the drug response outcome data includes data for at least 200 drugs

17. The system of claim 1, wherein the genomic data set includes at least one of the following: microarray expression data, microarray copy number data, PARADIGM data, SNP data, whole genome sequencing (WGS) data, RNAseq data, and protein microarray data.

18. The system of claim 1, wherein the potential research projects include a type of genomic data to collect related to the genomic data set.

19. The system of claim 15, wherein the type of genomic data to collect includes at least one of: microarray expression data, microarray copy number data, PARADIGM data, SNP data, whole genome sequencing (WGS) data, whole exome sequencing data, RNAseq data, and protein microarray data.

20. The system of claim 1, wherein the potential research projects include a type of clinical outcome data to collect related to the clinical outcome data set.

21. The system of claim 20, wherein the type of clinical outcome data to collect includes: IC50 data, GI50 data, Amax data, ACarea data, Filtered ACarea data, and max dose data.

22. The system of claim 1, wherein the potential research projects include a type of prediction study.

23. The system of claim 19, wherein the type of prediction study includes at least one of: a drug response study, a genome expression study, a survivability study, a subtype analysis study, a subtype differences study, a molecular subtypes study, and a disease state study.

24. The system of claim 1, wherein the at least one memory comprises a disk array.

25. The system of claim 1, wherein the at least one processor included a plurality of processors distributed over a network.

26. A method of generating machine learning results comprising:
storing, in a non-transitory computer readable memory, a training data set including:
a) a genomic data set representative of tissue samples taken from a cohort, and
b) a clinical outcome data set associated with the cohort and representative of clinical outcomes of the tissue samples after a treatment wherein the training data set are related to a plurality of potential research projects;
obtaining, via a modeling computer, a set of prediction model templates;
generating, via the modeling computer, an ensemble of trained clinical outcome prediction models by training the prediction model templates as a function of the genomic data set and the clinical outcome data set, wherein each trained clinical outcome prediction model comprises model characteristic metrics that represent attribute of the corresponding trained clinical outcome prediction model;
generating, via the modeling computer, a ranked listing of potential research projects selected from the of the plurality of potential research projects according to ranking criteria depending on the prediction model characteristic metrics of the plurality of trained clinical outcome prediction models; and
causing, via the modeling computer, a device to present the ranked listing of the potential research projects.

27. The method of claim 26, wherein the step of generating an ensemble of trained clinical outcome prediction models includes training a plurality of implementations of machine learning algorithms on the genomic data set and the clinical outcome data set.

28. The method of claim 27, wherein the plurality of implementations of machine learning algorithms includes at least ten different types of machine learning algorithms

29. The method of claim 26, wherein the prediction model characteristics metrics include at least one of the following performance metrics: an area under curve (AUC) metric, an R² metric, a p-value, an accuracy, accuracy gain, and a silhouette coefficient.

30. The method of claim 26, wherein the prediction model characteristics metrics include ensemble metrics.

31. The method of claim 30, wherein the step of generating the ranked listing of potential research projects includes ranking the potential research projects according to the ensemble metrics.
